(19) United States
(12) Patent Application Publication
(10) Pub. No.: US 2011/0175754 A1
(43) Pub. Date: Jul. 21, 2011

(54) Dynamic dashboard display

(75) Inventor: Dmitry Karpinsky, Scottsdale, AZ (US)

(73) Assignee: Dmitry Karpinsky, Scottsdale, AZ (US)

(21) Appl. No.: 12/657,300

(22) Filed: Jan. 20, 2010

(51) Int. Cl. B60Q 1/00; G08B 23/00

(52) U.S. Cl. 340/963; 340/461; 340/460; 340/436; 340/984; 704/246; 704/275; 345/173; 704/274

(57) ABSTRACT

This invention relates to an electronic instrument panel for vehicles consisting of information display that provides on-demand imaging where instruments are not in static, fixed position, but rather change in location, dimension, information presented based on conditions and environment the vehicle is in, and based on user or factory preferences and settings. The display can change colors, be self dimming and offer wide array of telemetry, entertainment, vehicle data, climate control, instrumentation, and powertrain information. The instrument panel will be online through wireless connectivity and provide the occupants real-time on-demand information about the vehicle and its surroundings through electronic display and human voice.

This application is a continuation-in-part of Ser. No. 12/499,128 files on Jul. 8, 2009, which is hereby incorporated by preference, as is set forth in full in this document, for all purposes.

### CROSS REFERENCE TO RELATED APPLICATIONS

| Patent # | Title | Date Issued |
|---|---|---|
| D571271 | Meter panel for an automobile | Jun. 17, 2008 |
| D562748 | Instrument panel for an automobile | Feb. 26, 2008 |
| D557646 | Vehicle dashboard panel | Dec. 18, 2007 |
| D546744 | Meter for motorcycles | Jul. 17, 2007 |
| D543139 | Instrument cluster for a vehicle | May 22, 2007 |
| D531557 | Instrument cluster | Nov. 7, 2006 |
| D529847 | Instrument gauge cluster | Oct. 10, 2006 |
| D529423 | Vehicle instrument cluster | Oct. 3, 2006 |
| D512357 | Instrument panel | Dec. 6, 2005 |
| D512006 | Instrument panel | Nov. 29, 2005 |
| D499998 | Instrumental panel for automobiles | Dec. 21, 2004 |
| D494908 | Surface configuration of a dashboard for a vehicle | Aug. 24, 2004 |
| D493757 | Surface configuration of a dashboard for a vehicle | Aug. 3, 2004 |
| D493756 | Instrument panel for an automobile | Aug. 3, 2004 |
| D492632 | Surface configuration of a dashboard for a vehicle | Jul. 6, 2004 |
| D491504 | Instrument for displaying information, for use in an automobile | Jun. 15, 2004 |
| D489660 | Instrument panel | May 11, 2004 |
| D483309 | Instrument gauge | Dec. 9, 2003 |
| D469391 | Surface configuration of a dashboard for a vehicle | Jan. 28, 2003 |
| D467845 | Surface configuration of an instrument display for a vehicle | Dec. 31, 2002 |
| 6404333 | Gauge Instrument for use in a motor vehicle | Jun. 11, 2002 |
| D440925 | Instrument display for a vehicle | Apr. 24, 2001 |
| D423434 | Automobile instrument panel | Apr. 25, 2000 |
| 5920256 | Gauge with Mechanical Indicator and Reconfigurable Gauge Display | Jul. 6, 1999 |
| 5272463 | Display device for vehicles | Dec. 21, 1993 |
| D276039 | Automobile instrument panel | Oct. 23, 1984 |

### FIELD OF THE INVENTION

This invention relates to vehicle information displays (also known as instruments, dashboards, panels, clusters, gauges), and particularly, to an information display for vehicle occupants where traditional dashboard and/or instrument panel exists.

### BACKGROUND OF THE INVENTION

The present invention relates to an instrument panel and gauges used for moving vehicles, including automobiles, aircraft, helicopters, motorcycles, watercraft (such as boats, yachts, jet skis, submersible crafts). This invention applies to any vehicle that requires manned or unmanned operator that has information display and control mechanisms.

The vehicle instrument panel has typically provided information concerning the operation of the vehicle, time, outside temperature, and the like. Instruments concerning operation of the vehicle have traditionally been located in the panel in front of the vehicle operator within the dashboard. Ancillary electronic displays, such as clock, climate control, radio, GPS mapping, and the like, were also located in the panel often in the middle between the driver and the passenger so as to be viewed and regulated by both, the driver and passenger. Various knobs, switches and buttons were scattered throughout the vehicle.

These instruments are static and in fixed position. These instruments often include a speedometer for indicating the speed of the vehicle, a tachometer for showing the speed of the engine, and various other gauges for showing engine temperature and fluid levels, for example. Similar instrumentation is present on aircraft, boats, motorcycles and other vehicles. For example, the speedometer and the climate control are in the same position hardwired or fastened in any given vehicle; same size and do not move. The only thing that changes is the information display produced by the gauges, or how a switch was adjusted, in the on or off position, until the next adjustment by the operator or the passenger.

These instruments often include analogue gauges wherein a needle or pointer is mounted on the rotary output shaft of a gauge motor and assumes different positions based on the control signal received by the gauge. The needle is positioned near a display bearing markings relevant to the condition being measured, and the needle points to various marks as it turns. For example, if the gauge is part of a speedometer, the markings on the display will indicate various rates of speed in miles or kilometers per hour. Sensors measure the rate of speed of the vehicle and send signals proportional to that speed to the gauge causing the needle to point to the appropriate marking on the display. Toffolo et al (U.S. Pat. No. 5,920,256) presented a reconfigurable gauge display, but that was for mechanical gauges which could not be electronically moved on-demand from one location to another within the vehicle in real-time. There have been many utility and design patents issued for instrument panels (D571271, D562748, D557646, D546744, D543139, D531557, D529847, D529423, D512357, D512006, D499998, D493756, D491504, D489660, D483309, D467845, D440925, D423434, D276039, U.S. Pat. Nos. 6,404,333, 5,272,463), but they all have fixed analog or electronic gauges that cannot be moved along the dashboard of the vehicle in a graphical format. A few patents (D494908, D493757, D492632, D469391) discussed configuration of the dashboard, but those do not have electronic information displays contouring the vehicle, nor do they have adjustable gauges or information panels.

Instrumentation must be visible to a person operating a vehicle, and many of the instruments must be read while the vehicle is in motion. A driver will generally focus on the road in front of him when driving, and thus the most convenient location for placing instrumentation has been directly below the driver's gaze, on the dashboard of the vehicle. Furthermore, the most important instruments must be large enough for the driver to read and interpret quickly. A vehicle traveling at 60 miles per hour moves 88 feet per second. Thus a driver takes his eyes off the road for 88 feet every time he looks at an instrument for one second. If the instrumentation is small or cannot be read quickly, or if driver reads several gauges in same glance, an even greater time will elapse. In addition, a person's eyes take a certain amount of time to adjust when shifting focus from a distant point to a proximate point, and a similar time elapses when attention is returned to the distant point. Changes in lighting between the interior and exterior of the vehicle can also make it difficult to switch focus between the road and the dashboard. The constant shifting of attention from the road to the instruments and the re focusing of eyes involved in this process can be distracting and had the potential to contribute to the occurrence of accidents.

It is argued that same instrument cluster layout should not be same for everyone or every situation. If a driver is on a freeway, a speedometer may be the most important gauge. If the vehicle is low on gas with few gas stations in the area, the gas gauge and GPS showing nearest gas station may be the most important. If a truck, carrying heavy load is climbing up a mountain, a tachometer, temperature or oil gauge may be the most important. If a taxi driver is trying to find the next location, navigation system may be the most important. An elderly individual may need a larger or better lighted gauge than a younger counterpart. Yet, all the gauges and displays have traditionally remained in their same static position as preset by the factory.

Recently, some manufacturers have implemented a heads-up display (HUD) which projects information onto the interior of the windshield directly in front of the vehicle operator. However, this technology still presents the same gauges, in fixed position, and is often difficult to read in daylight hours.

No one has previously provided Dynamic Dashboard Displays for vehicles. These displays are configurable within the dashboard and are dynamic in nature. The display provides on-demand information based on user preferences, where gauges are not static but rather may change shape, be added or deleted, be moved from one location on the instrument panel to another, change colors, and information produced and displayed.

### SUMMARY OF THE INVENTION

The object of the present invention provides information to an operator and occupants of the motor vehicle through an electronic dynamic dashboard display. The display system is designed to serve as a centralized control point for most vehicle comfort, entertainment, safety and information display functions. The use of microprocessor based display controller of this type also facilitates advanced functions such as sophisticated trip computer functions, online Internet connectivity, Bluetooth connectivity and synchronization with personal digital assistants, mobile phone, voice response, GPS functionality and mapping including traffic, weather, location-based networking and integration with home automation and external computers, to name a few. Parts of the display are touch sensitive which allow user to adjust settings such as radio, climate control system, GPS unit or move gauges around. The display can also, inform the occupants about any road hazards, warnings or present information in a human voice. The display gauges may be adjusted moved, resized, added or deleted by the vehicle occupant. For example, during a long trip, a speedometer may be in the middle of the dash, while when the same truck is pulling a heavy load, tachometer may be displayed where speedometer once was. Another example is of a driver driving along the freeway when a deer jumps in front of the vehicle. At that instance the vehicle avoidance system detects the deer and the main speedometer gauge disappears and is replaced with a warning blinking sign with sound indicating to the driver that there is imminent danger. These displays may be changed by vehicle occupants or set by manufacturer. Instead of being hard-wired or fastened into the dash, the displays will be dynamic within the electronic dashboard.

The main objectives of Dynamic Dashboard Display are ability to dynamically:

1) digitally display vehicle gauges;

2) move gauge;

3) resize gauge;

4) delete gauge;

5) make gauge visible;

6) configure gauges to users preferences;

7) change the gauge attributes such as color, fonts, graphics; and,

8) provide vital information in real time as information becomes available.

### DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain in the principles of the invention.

FIG. 1 is a top view, depiction A with a perspective view showing an instrument panel unit including an instrument panel and a vehicle body frame section according to an embodiment of the present invention;

FIG. 2 is a top view, depiction B with a perspective view showing an instrument panel unit including an instrument panel and a vehicle body frame section according to an embodiment of the present invention;

FIG. 3 is the perspective view of the instrument front panel, what front occupants would see directly in front of them. The steering wheel is on the left (another option for it to be on the right);

FIG. 4 is a sample of Dynamic Dashboard Display representation;

FIG. 5 is alternative sample of Dynamic Dashboard Display representation.

### DETAILED DESCRIPTION OF THE INVENTION

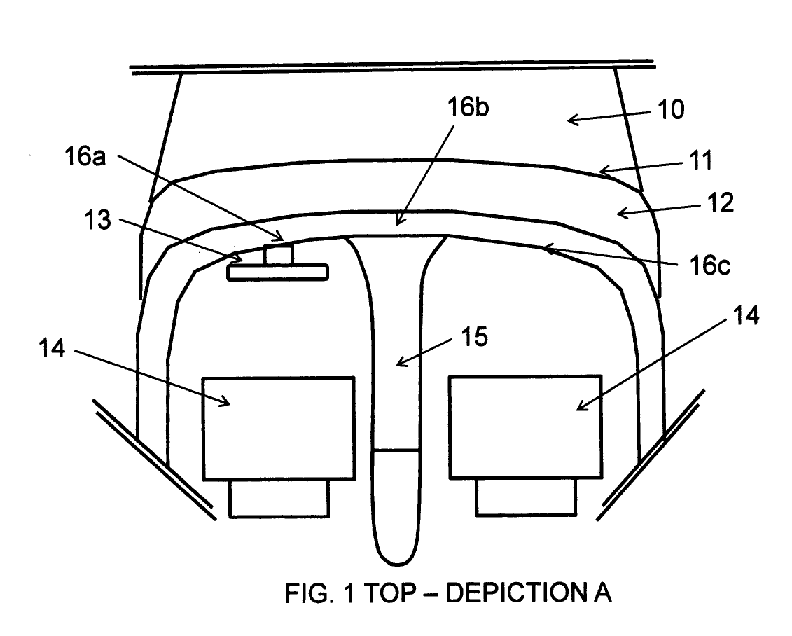

For the purposes of the following description, the terms “upper,” “lower,” “right,” “left,” “vertical,” “horizontal,” and derivatives or equivalents thereof shall relate to the invention as oriented in FIG. 1. It is understood that the invention may assume various alternative orientations, except where expressly specified to the contrary. It is also understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not considered limiting unless the claims expressly state otherwise. Accordingly, various modifications may be made without departing from the spirit of scope of the general inventive concept as defined by the appended claims and their equivalents.

An embodiment of the present invention will be described below with reference to the accompanying drawings.

Referring now in detail to the drawings and in particular to FIG. 1 thereof, the numeral 10 denotes generally a motor vehicle. The vehicle includes a windshield 11, top of dashboard 12, steering wheel 13, seats 14, dividing console between occupants 15, and the Dynamic Dashboard Display 16 of this invention. The Dynamic Dashboard Display 16 can be fitted anywhere in the dash, such as in front of the driver 16a, in center console 16b, in front of passenger 16c, in the doors or even in the back seat rests. The center console, where a traditional gear shifter is located can be replaced with a Dynamic Dashboard Display with series of touch screen controls or buttons in its place. Also, another depiction could be a mirror image where a steering wheel can be located on the right side.

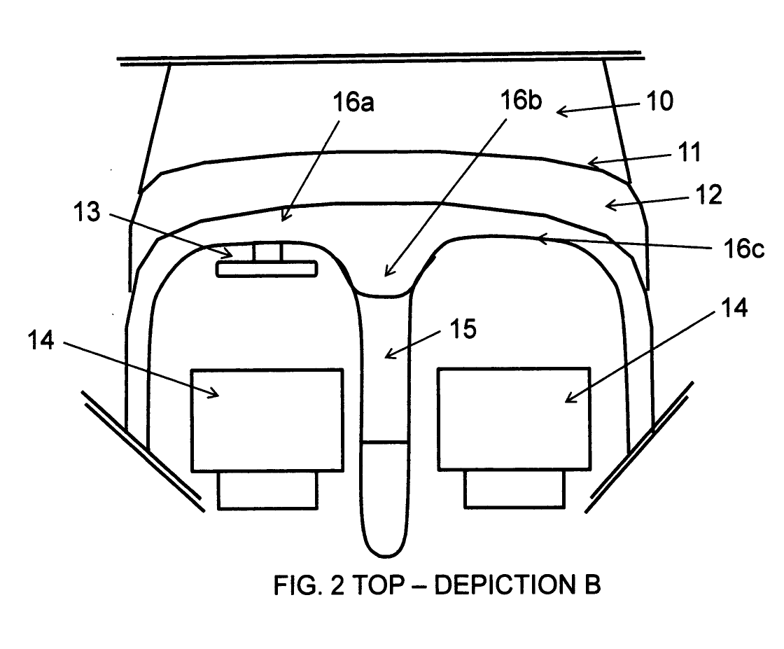

With reference to FIG. 2 of the drawings, which is another depiction of FIG. 1, it may be appreciated that Dynamic Dashboard Display can wrap around concave shape in the mid console 16b. Also, another depiction could be a mirror image where a steering wheel can be located on the right side.

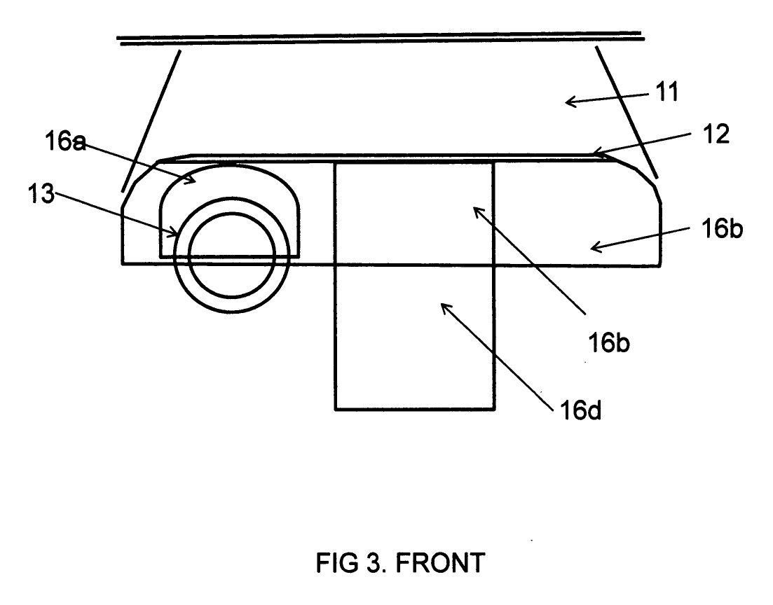

FIG. 3 shows where the Dynamic Dashboard Display could be placed if the vehicle occupant was to look directly forward, or ahead, without looking at sides. The Dynamic Dashboard Display can be placed in front of the driver 16a, in front of the passenger 16c, or it can be placed along the center console 16b. Along the center console, Dynamic Dashboard Display can be situated at the top or down towards the gearshift 16d. The Dynamic Dashboard Display can be of any size or dimension that the space would allow for it. It can be of any shape such as rectangle, round, semi-circle, etc. Dynamic Dashboard Display can also be placed in the doors or headrests of vehicles to provide information to the rear passengers.

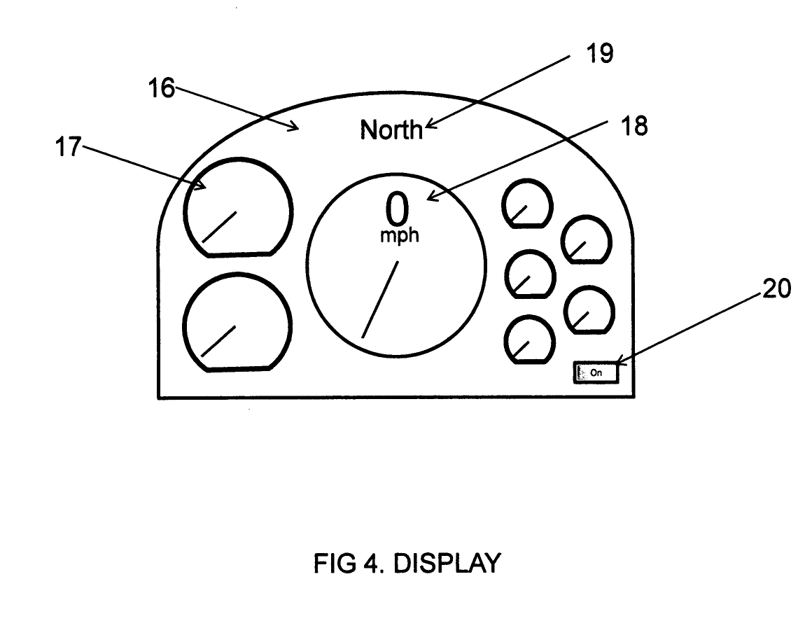

FIG. 4 represents a close-up of the Dynamic Dashboard Display in one embodiment 16. The size and shape of Dynamic Dashboard Display can vary but the principles would be similar. Within Dynamic Dashboard Display the gauges or information can be configured in any way. For example, one configuration may be where main gauge can be in the center 18. Primary gauges can be to the left 17 and minor gauges can be to the right. The Dynamic Dashboard Display can also have textual information 19 and graphical representation of buttons or switches 20. The buttons could be touch sensitive or display information only. They can be grayed out if user cannot use the touch screen, or if that capability is disabled. The buttons can also be deleted from the screen. The cluster can be configured by the factory as preset configuration. It can be configured by the dealership or service station. Or it can be configured by the vehicle occupant. To configure the cluster there are several options.
A) The Dynamic Dashboard Display can be configured through menu options within the Dynamic Dashboard Display.
B) Dynamic Dashboard Display can be configured through “drag and drop” touch screen controls.
C) Dynamic Dashboard Display can be configured through voice commands.
D) Dynamic Dashboard Display can be configured through online download where a user can “build the configuration” on remote computer, save that configuration and then upload it to the vehicle through wired or wireless connection. For the wired connection, a USB or similar port can be located within the vehicle. For wireless connection, the information can be transmitted through Bluetooth or any other wireless service.

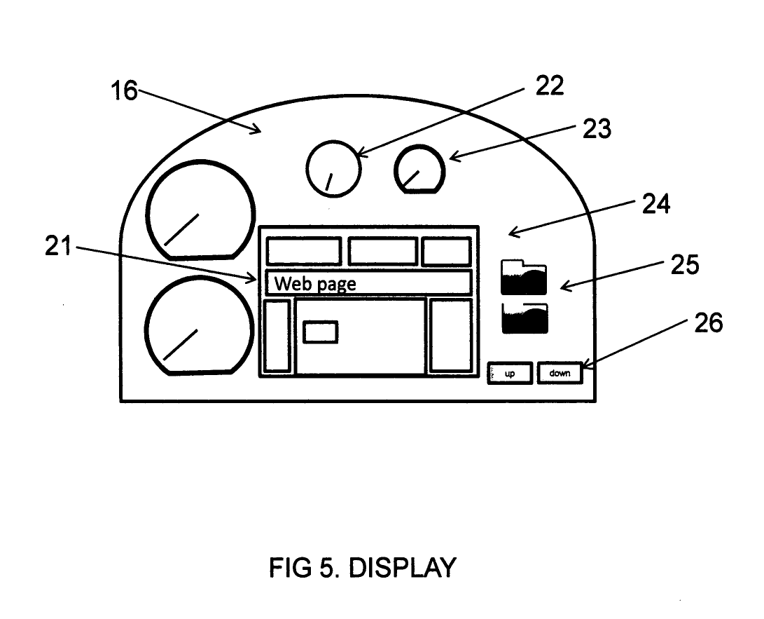

FIG. 5 is an alternative view of the Dynamic Dashboard Display 16. This is the same Display as FIG. 4, except as shown, the gauges have been moved. A user could, for instance, bring up a web page or a video 21. The main gauge could be moved to the top and resized 22 and minor gauge can be moved to the top as well. Other gauges can be deleted 24. Various icons could be displayed 25, 26. The gauges and icons could be touch sensitive where the system allows the user to manipulate the screen through touch, menus, voice or buttons located elsewhere within the vehicle. The system can also have a built-in hard drive or a memory card to store user preferences when multiple drivers use the vehicle or use it in varying conditions.

In other examples, user can minimize tachometer and place it to left of speedometer, which user can make larger. The next day the driver may want to replace tachometer with a temperature gauge and instead of dial-type, make it bar-type and place it to the right of speedometer. User could set threshold that if vehicle goes over 75 mph to display and voice prompt a warning to the driver. A driver could set her house thermostat to lower setting through wireless integration with home automation system prior to arriving home. Telematic video conferencing, weather & traffic reports, GPS vehicle tracking and remote assistance would all be possible through integration with the unit. For entertainment, the passengers could play videos, movies, in-vehicle games, online games, listen to music or mp3 players, and talk on their phone through wireless integration such as Bluetooth. Parental controls could be enforced by limiting the vehicle speed, time of day vehicle can be controlled and areas the vehicle may not travel beyond or to allow through GPS and navigation controls. If the vehicle is stolen, the owner could remotely disable the vehicle and locate it through location-based services. The system would memorize preferences of several drivers. Vehicle collision avoidance system can deploy safety devices milliseconds before unavoidable collision. The system could warn the driver of road hazards ahead or display night vision through Dynamic Dashboard Display. The Dynamic Dashboard Display is integrated with the vehicle onboard computer system and allows the system to display gauges that are appropriate for that instance in time based on logic and rules.

The above description is considered that of the preferred embodiments only. Modification of the invention will occur to those skilled in the art and to those who make and use the invention. Therefore, it is understood that the embodiments shown in the drawings and described above are merely for illustrative purposes and are not intended to limit the scope of the invention, which is defined by the following claims. Graphical user interface (GUI) creativity would dictate how the panel is laid out with what components available to the occupants.

The embodiments of the invention in which an exclusive property or privilege is claimed are defined as follows:

1. A Dynamic Dashboard Display for use in vehicles comprising:
a. an information instrument panel body made of electronic display;
b. instrument panel that shows on-demand real-time displays, which comprise any of the following:
i. static gauges in fixed position;
ii. automatically adjusting and configurable gauges which adjust according to vehicle conditions and options of the vehicle occupants;
iii. manually adjusting and configurable gauges configured based on user preferences;
iv. adjustable attributes in real-time in placement, size, dimension, color and information displayed;
v. can be of any dimension or shape that would allow for it to fit within the vehicle;
vi. ability to move the gauge anywhere within the electronic dashboard, resize the gauge, delete a gauge, make a gauge visible.

2. A Dynamic Dashboard Display as claimed in claim 1, wherein said invention is to be used in any moving vehicle including automobiles, aircraft, helicopters, motorcycles, watercraft (boats, yachts, jet skis, submersibles), military equipment (such as tanks, aircraft, submarines, ships);

3. A Dynamic Dashboard Display as claimed in claim 2, wherein said invention provides means to electronically display graphics, text, video or moving images to vehicle occupants;

4. A Dynamic Dashboard Display as claimed in claim 3, wherein said invention may include touch-screen, menu driven or voice activated controls;

5. A Dynamic Dashboard Display as claimed in claim 4, wherein said invention has the ability for occupants to move and select the gauges, on-screen information and menus through touch-screen drag and drop controls with a finger, voice commands or configuration loaded from remote computer through wired or wireless interface;

6. A Dynamic Dashboard Display as claimed in claim 5, wherein said invention has the information arranged through menus, folders, gauges, and controls;

7. A Dynamic Dashboard Display as claimed in claim 6, wherein said invention having storage means such as hard drive, disk or memory card to store vehicle information, external information and occupant display preferences;

8. A Dynamic Dashboard Display as claimed in claim 7, wherein said invention contains transmitting and wireless capability with external devices such as personal digital assistants and wireless connectivity for network and phone connections;

9. A Dynamic Dashboard Display as claimed in claim 8, wherein said invention has an ability for instrument display to announce in human voice the reading of gauges and/or emit warnings and having voice recognition capability based on user and/or factory predefined thresholds and control limits;

10. A Dynamic Dashboard Display as claimed in claim 9, wherein said invention has an ability to emit warnings or alerts if collision avoidance system is triggered;

11. A Dynamic Dashboard Display as claimed in claim 10, wherein said invention has an ability to adjust light, color of the gauges and information display;

12. A Dynamic Dashboard Display as claimed in claim 11, wherein said invention has an ability for the vehicle occupants to select personal preferences of look and feel of the information panel;

13. A Dynamic Dashboard Display as claimed in claim 12, wherein said invention integrates with vehicle computer, vehicle diagnostics and measuring devices.
